(19) United States
(12) Patent Application Publication
(10) Pub. No.: US 2005/0122298 A1
(43) Pub. Date: Jun. 9, 2005

(54) [PROGRAMMABLE GAMMA CIRCUIT AND DISPLAY APPARATUS THEREWITH]

(76) Inventors: Jyi-Maw Hung, Chiayii City (TW); Min-Chien Kuo, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,365

(22) Filed: Feb. 26, 2004

(30) Foreign Application Priority Data
Dec. 4, 2003 (TW) 92134146

(51) Int. Cl. G09G 3/36; H04N 5/222

(52) U.S. Cl. 345/94

(57) ABSTRACT

A programmable Gamma circuit and display apparatus therewith are provided, wherein the programmable Gamma circuit includes a controller and a plurality of gamma units. The controller receives a control signal externally, and outputs a plurality of Gamma setup signals. Each of the gamma setup signals is comprised of a plurality of bit signals in digital form. The control signal can be transmitted via I²C or 3-wire interface bus according to one preferred embodiment in this present invention, so as to reduce number of pins to the driving circuit (IC). Each Gamma unit receives a gamma setup signal, and outputs a corresponding Gamma voltage signal accordingly.

### CROSS REFERENCE TO RELATED APPLICATIONS

This application claims the priority benefit of Taiwan application 92134146, filed Dec. 4, 2003.

### BACKGROUND OF INVENTION

1. Field of the Invention

This invention generally relates to a Gamma modifier in an imaging processing circuit, and more particularly to a digital programmable Gamma voltage modification circuit and display apparatus therewith.

2. Description of Related Art

An immense variety of imaging application products is available in market in current days, where Gamma circuit is commonly included in circuitry of those products. For example, in order to drive a liquid crystal of a liquid crystal display (LCD) for displaying images, a driving voltage is applied to a liquid crystal to rotate which by an angle, this driving voltage is provided by an image signal (usually a digital signal) after conversion. However, the image signal, driving voltage amplitude, liquid crystal angle, and pixel transmittance are not linearly related to each other, therefore a Gamma circuit is necessary for voltage manipulation for image signal modification.

Referring to FIG. 1a, it is a block diagram illustrating a Gamma circuit embedded in a display according to conventional art. Referring to FIG. 1b, it is a diagram illustrating Gamma circuit 150 in FIG. 1a. Referring to FIG. 1c, it is a diagram illustrating Gamma Circuit 140 in FIG. 1a. Referring to FIGS. 1a, 1b, and 1c, a driving circuit 120 is packaged as an integrated circuit (IC) and processed on a glass substrate, whereas the control/modify circuit 130 is embodied on a Printed Circuit Board (PCB). Generally speaking, an image driving circuit 120 includes a Gamma circuit 140, wherein a plurality of resistors R41˜R4n are connected serially and voltage is divided thereby. The divided voltages are amplified by voltage followers OP₄₁˜OP₄ₙ current wise to form Gamma voltages G₁˜Gₙ. However, the Gamma circuit 140 is included in the driving circuit 120, thus voltage dividers R41˜R4n ratio is fixed in resistance after wafer is processed. In addition to default Gamma voltages G₁˜Gₙ, extra pins for external Gamma voltages M₁˜Mₙ are reserved on the package of driving circuit 120 for higher flexibility.

In conventional art, if the default values G₁˜Gₙ are to be changed in the driving circuit 120, another Gamma circuit 150 is added to the control/modify circuit 130 for providing voltage values M₁˜Mₙ. It was commonly done with serially connected resistors R₅₁˜R₅ₙ in the Gamma circuit 150 in conventional art, where voltage is divided and processed with voltage follower OP₅₁˜OP₅ₙ for current amplification to form Gamma voltages M₁˜Mₙ. In the figure, each of the voltage dividers are constructed with two resistors, for example, the resistor R₅₁ is comprised of resistors R₅₁ₐ and R_{51b} connected in series. The reason why dispatching the resistors as mentioned above is because practically not all proper values of resistors are available; in order to avoid changing resistors yet retaining original divided voltage ratio, it is set up as described.

In conventional art, Gamma voltages are generated externally in replace of the embedded Gamma circuit of driving IC, thus circuit functionality is repeated and power consumption is burdened. Also, external Gamma circuit requires a plurality of additional Gamma resistors and operational amplifiers, thus parts cost increases as well as area of PCB. Another Gamma circuit is provided for possible Gamma voltage modification in conventional art, yet it is not eligible to modify after manufactured. Besides, before manufactured when one of the M₁˜Mₙ provided by Gamma circuit 150 is to be changed, all of the dividing resistors R₅₁˜R₅ₙ are required to be modified in the Gamma circuit 150, which is very inconvenient and time consuming for circuit designers.

### SUMMARY OF INVENTION

The present invention provides a programmable Gamma circuit. The Gamma circuit comprises a controller and a plurality of Gamma units. The controller receives external control signals, and outputs a plurality of Gamma setup signals according to the control signals. Each Gamma setup signal is comprised of a plurality of bit signals in digital form. According to one preferred embodiment of the present invention, the control signals are transmitted via I²C or 3-wire interface bus, so that number of pins of driving IC is reduced. Each Gamma unit receives a Gamma setup signal, and outputs a corresponding Gamma voltage signal upon the Gamma setup signal that is received.

According to one preferred embodiment of the present invention, the foregoing Gamma unit includes an operational amplifier and a plurality of Gamma resistors. Each of the Gamma resistors has a first terminal and a second terminal, and the first terminal of each of the Gamma resistors receives one of the bit signals from each of the Gamma setup signals. The second terminal of each of the Gamma resistors is coupled together for outputting a summed up current from the gamma resistors as a Gamma current. The amplifying unit is for receiving the Gamma current, and transferring which to a corresponding Gamma voltage signal for output. The foregoing amplifying unit, including a feedback resistor and an operational amplifier, is exemplary in a preferred embodiment of the present invention. The feedback resistor has a third terminal and a fourth terminal, and the operational amplifier has a first input terminal, a second input terminal and an output terminal. The first input terminal of the operational amplifier is coupled to a voltage level, and the second input terminal is coupled to the third terminal of the feedback resistor and receives the Gamma current. The output terminal of operational amplifieris coupled to the fourth terminal of the feedback resistor for outputting Gamma voltage signal. Wherein the voltage level is ground voltage level or any direct voltage level.

The present invention is applied to display apparatus, or a liquid crystal display for further description, yet not limiting the scope of the present invention thereby. Display apparatus is merely one of the applications for the present invention.

The present invention provides another programmable Gamma circuit, including an amplifying unit and a plurality of Gamma resistors. A plurality of external Gamma setup signals is provided in digital form. Each of the Gamma resistors has a first terminal and a second terminal, where the first terminal receives one of the Gamma setup signals, and the second terminal is coupled together and outputs a summed Gamma current from each of the Gamma resistors. The amplifying unit is for receiving the Gamma current, and transfers which to a corresponding Gamma voltage signal.

The amplifying unit provides a simple circuit in one preferred embodiment, including a feedback resistor and an operational amplifier. Wherein the feedback resistor has a third terminal and a fourth terminal, whereas the operational amplifier has a first input terminal, a second input terminal and an output terminal. The first input terminal of the operational amplifier is coupled to a voltage level; the second input terminal is coupled to the third terminal of the feedback resistor and receives the Gamma current. The output of the operational amplifier is coupled to the fourth terminal of the feedback resistor and outputs the Gamma voltage signal. Wherein the voltage level is ground voltage level or any other direct voltage level.

The present invention adopts I²C or 3-wire transmission interface bus for control signal transmission, thus number of IC pins is significantly reduced comparing to conventional IC. On the other hand, programmable Gamma voltage is also provided, thus external Gamma circuit is eliminated, so that chip area is saved, power consumption is reduced, and cost is lowered. Most significantly, the present invention provides possible modification of Gamma voltages upon user's request at any time.

The present invention provides a display apparatus, including a display panel, a control/modify circuit and a driving circuit. The control/modify circuit outputs a plurality of Gamma setup signals in digital form including a plurality of bit signals. The driving circuit is coupled to the control/modify circuit and the display panel, wherein the driving circuit includes a programmable Gamma circuit. The programmable Gamma circuit receives a plurality of Gamma setup signals, and outputs corresponding Gamma voltage signals.

According to the preferred embodiment of the present invention, the programmable Gamma circuit includes a plurality of Gamma units, each Gamma unit receives one of the Gamma setup signals, and outputs one of the corresponding Gamma voltage signals according to the Gamma setup signals that is received. Notice that the display panel is liquid crystal display, for example.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1a is a diagram illustrating a Gamma circuit for a display apparatus according to a conventional art.

FIG. 1b is a circuit diagram illustrating the Gamma circuit 150 in FIG. 1a according to conventional art.

FIG. 1c is a circuit diagram illustrating the Gamma circuit 140 in FIG. 1a according to conventional art.

FIG. 2 is a block diagram illustrating a programmable Gamma circuit according to one preferred embodiment of the present invention.

FIG. 3 is a block diagram illustrating the programmable Gamma circuit 240 in FIG. 2 according to one preferred embodiment of the present invention.

FIG. 4 is a circuit diagram illustrating the Gamma unit 244 according to one preferred embodiment of the present invention.

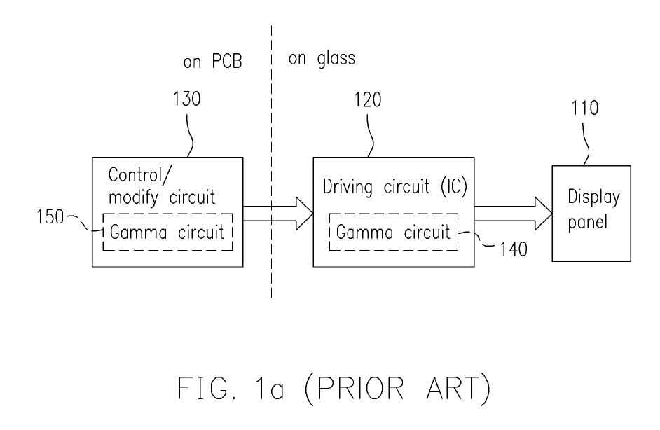

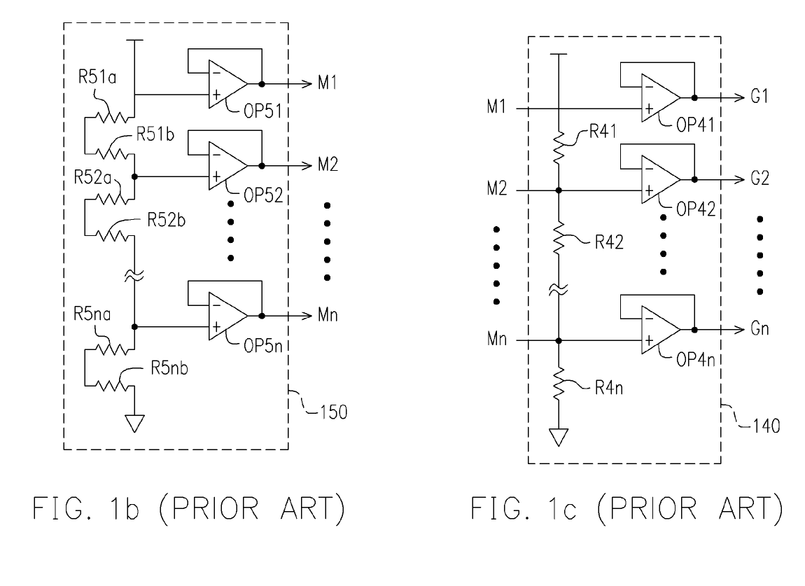

### DETAILED DESCRIPTION

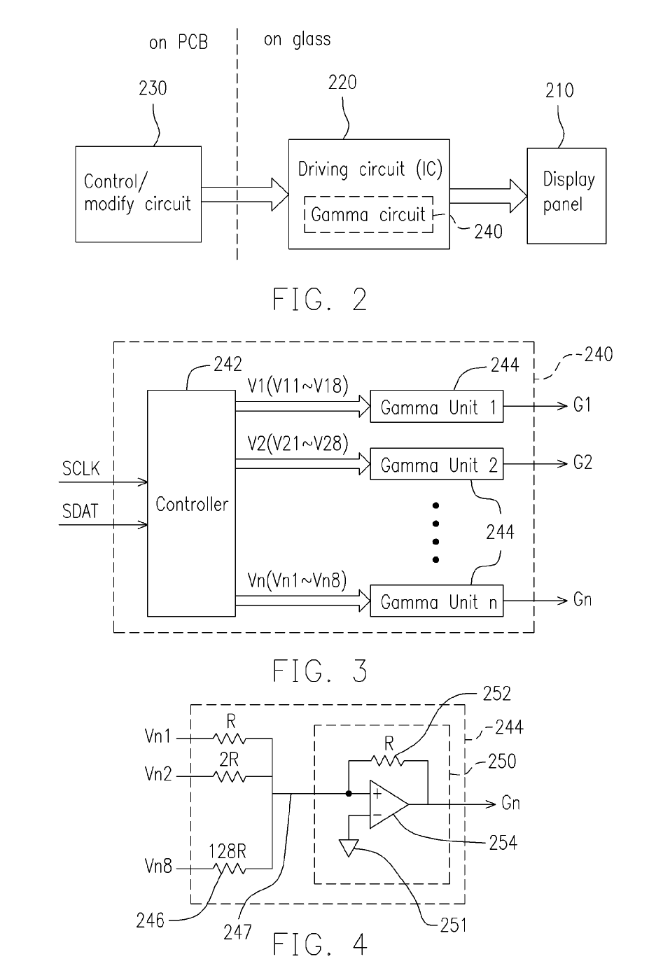

Referring to FIG. 2, it is a block diagram illustrating a programmable Gamma circuit according to one preferred embodiment of the present invention. FIG. 2 is a block diagram illustrating the programmable Gamma circuit 240 in FIG. 2. FIG. 4 is a block diagram illustrating the programmable Gamma unit 244 in FIG. 3 according to one preferred embodiment of the present invention. Referring to FIGS. 2, 3 and 4. For further description of the present invention, liquid crystal display is exemplary hereinafter. The liquid crystal display has a display panel 210, wherein images are comprised of a plurality of pixels of the display panel 210. The pixels perform along with transmittance variation upon liquid crystal rotation, which is controlled by different driving voltage. The driving circuit 220 for providing driving voltage is integrated to an IC and is disposed on a same glass substrate with the display panel 210. On the other hand, the PCB technology applies to the control/modify circuit 230 for providing control and clock signals for the driving circuit 220. The pre-embedded Gamma circuit of the driving circuit 220 is entirely integrated to the programmable Gamma circuit 240 accordingly.

In the present invention, such as I²C or 3-wire interface buses are applied to the programmable Gamma circuit 240. Therefore number of IC pins is significantly reduced. In one preferred embodiment of the present invention, I²C interface bus is exemplary. I²C interface bus is a two-wire transmission interface, having a serial data line SDAT and serial clocking line SCLK. Control signals are transmitted serially externally via the serial data line SDAT to the controller 242. The controller 242 captures the control signal via the serial data SDAT upon the serial clock signal SCLK triggers. The controller 242 sets off and keeps a plurality of Gamma setup signals V₁˜Vₙ according to the control signals, and each of the Gamma setup signals are comprised of a plurality of bit signals in digital form. For example, the Gamma setup signal Vₙ is an 8-bit signal, represented by bit signal Vₙ₁ to bit signal Vₙ₈ in this preferred embodiment of the present invention.

Each of the Gamma units 244 receives the corresponding Gamma setup signal, and determines a Gamma voltage for outputting according to the Gamma setup signal that is received. The n^{th} Gamma unit is described as an example herein, whereas other Gamma units are not repeated hereafter. The Gamma unit 244 receives the Gamma setup signal Vₙ, wherein the Gamma setup signal Vₙ includes bit signal Vₙ₁ to bit signal Vₙ₈. In the preferred embodiment of the present invention, the Gamma unit 244 includes eight Gamma resistors, which possess resistance of R, 2R, 4R, 8R, 16R, 32R, 64R, and 128R respectively, for example, where R is a positive number. In favor of description convenience, the resistors are named after their resistance hereinafter. Referring to FIG. 2, the Gamma resistor R receives the Gamma setup signal Vₙ₁, the Gamma resistor 2R receives the Gamma setup signal Vₙ₂, and likewise for the rest of Gamma setup signals. Each of the Gamma resistors receives bit signals for generating current, and summing up each current from the Gamma resistors as the Gamma current 247. The amplifying unit transfers the Gamma signal 247 to a Gamma signal Gₙ for outputting accordingly.

A simple circuit of amplifying unit 250 is embodied in one preferred embodiment of the present invention, including a feedback resistor 252 and an operational amplifier 254. Wherein one input terminal of the operational amplifier 254 is coupled to the voltage level 251 and the other input terminal is coupled to the feedback resistor for receiving the Gamma current 247. The output terminal of the operational amplifier 254 is coupled to the feedback resistor 252 and outputs the Gamma voltage signal Gₙ. The voltage level 251 is ground voltage level, for example, or any other direct voltage level. The resistance of the feedback resistor 252 is R ohms, for example, where R is a positive number.

When the Gamma setup signal Vₙ is 00000001, for example, the bit signal Vₙ₁ is at high voltage level (e.g. v volts), and the rest bit signals Vₙ₂˜Vₙ₈ are at low voltage level (e.g. 0 volt). The gamma current 247 is thus v/R amperes, and the Gamma voltage signal Gₙ is (v/R)R=v. If the Gamma setup signal Vₙ is 00000010, for example, the bit signal Vₙ₂ is at high voltage level, and the rest of the bit signals Vₙ₁, Vₙ₃˜Vₙ₈ are at low voltage levels. Where the Gamma current 247 is v/2R amperes, and the Gamma voltage signal Gₙ is (v/2R)R=v/2. Also when the Gamma setup signal Vₙ is 00000011, for example, that is the bit signals Vₙ₁ and Vₙ₂ are at high voltage level, and the rest of bit signals Vₙ₃˜Vₙ₈ are at low voltage level. The Gamma current 247 is then (v/R)+(v/2R)=3v/2R amperes, and the Gamma voltage signal Gₙ is thus (3v/2f)R=3v/2. Therefore by controlling signals (SCLK+SDAT) manage to setup each of the Gamma units 244 for outputting expected Gamma signals G₁˜Gₙ.

It is noted that for the skill in the art, number and resistance of the resistors 246 can be modified upon request, and the combinations of the bit signals of the Gamma setup signals are not limited. Variations of aforementioned are also within the scope of the present invention.

Referring to FIGS. 2, 3, and 4 for another preferred embodiment of the present invention. This present preferred embodiment is similar to the previous preferred embodiment, whereas the controller 242 of the programmable Gamma circuit 240 is omitted, yet programmable setup signals V₁˜Vₙ in digital form are provided externally.

Referring to FIG. 2 again for another preferred embodiment of the present invention. The output signals of the control/modify circuit 230 in this preferred embodiment includes a plurality sets of Gamma setup signals V₁˜Vₙ, and are transmitted to the driving circuit 220, for example. The Gamma setup signals are in digital form and each of the Gamma setup signals includes a plurality of bit signals. The driving circuit 220 has programmable Gamma circuit, which serves to receive each set of the programmable setup signals, and output corresponding Gamma voltage signals according to the Gamma setup signals. In this preferred embodiment, the programmable Gamma circuit includes a plurality of Gamma units, each of the Gamma unit receives one of the Gamma setup signals, and outputs one of the corresponding Gamma setup signals upon the Gamma setup signal that is received. The Gamma unit is embodied according to FIG. 4, for example, which is similar to the previous preferred embodiment, thus is not repeated herein.

Moreover, when the Gamma voltages G₁˜Gₙ are modified according to the characteristics of the display, designers manage to merely modify the control signals of the control/modify circuit 230 to obtain different values of the Gamma setup signals V₁˜Vₙ for obtaining the Gamma voltages G₁˜Gₙ as expected. Yet comparing to conventional art, the present invention is superior whereas all resistors needed to be modified for varying Gamma voltages in prior art.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A programmable Gamma circuit, comprising:
a controller, receiving a control signal externally, and outputting a plurality of Gamma setup signals according to the control signal, wherein the Gamma setup signals are in digital form and each of the Gamma setup signals comprises a plurality of bit signals; and
a plurality of Gamma units, wherein each of the Gamma units receives one of the Gamma setup signals and outputs a Gamma voltage signal corresponding to the Gamma setup signals.

2. The programmable Gamma circuit as recited in claim 1, wherein the control signal is transmitted via I²C interface bus in an integrated circuit.

3. The programmable Gamma circuit as recited in claim 1, wherein the control signal is transmitted via 3-wire interface bus.

4. The programmable Gamma circuit as recited in claim 1, wherein each of the Gamma units comprises:
a plurality of Gamma resistors, each of the Gamma resistors having a first terminal and a second terminal, the first terminal of any one of the Gamma resistors receives one of the bit signals of the Gamma setup signals correspondingly, the second terminal of each of the Gamma resistors is coupled together where current outputted from each of the Gamma resistors is summed up to a Gamma current; and
an amplifying unit, receiving the Gamma current and outputting the Gamma voltage signal correspondingly.

5. The programmable Gamma circuit as recited in claim 4, wherein the amplifying unit comprises:
a feedback resistor, having a third terminal and a fourth terminal; and
an operational amplifier, having a first input terminal, a second input terminal and an output terminal, wherein the first input terminal is coupled to a voltage level, the second input terminal and the third terminal of the feedback resistor are coupled and receive the Gamma current, and the output terminal and the fourth terminal of the feedback resistor are coupled and output the Gamma voltage signal.

6. The programmable Gamma circuit as recited in claim 5, wherein the voltage level is ground voltage level.

7. The programmable Gamma circuit as recited in claim 1, wherein the programmable Gamma circuit applies to a driving circuit for a display apparatus.

8. The programmable Gamma circuit as recited in claim 7, wherein the display apparatus is a liquid crystal display.

9. A programmable Gamma circuit, comprising:
a plurality of Gamma resistors, each of the Gamma resistors having a first terminal and a second terminal, the first terminal of any one of the Gamma resistors receiving one of a plurality of Gamma setup signals, each of the Gamma setup signals being in digital form, and the second terminal of each of the Gamma resistors being coupled together where current outputted from each of the Gamma resistors is summed up to a Gamma current; and
an amplifying unit, receiving the Gamma current and outputting a Gamma voltage signal correspondingly.

10. The programmable Gamma circuit as recited in claim 9, wherein the amplifying unit comprises:
a feedback resistor, having a third terminal and a fourth terminal; and
an operational amplifier, having a first input terminal, a second input terminal and an output terminal, wherein the first input terminal is coupled to a voltage level, the second input terminal is coupled to the third terminal of the feedback resistor and receives the Gamma current, and the output terminal and the fourth terminal of the feedback resistor are coupled and output the Gamma voltage signal.

11. The programmable Gamma circuit as recited in claim 10, wherein the voltage level is ground voltage level.

12. The programmable Gamma circuit as recited in claim 9, wherein the programmable Gamma circuit applied to a driving circuit of a display apparatus.

13. The programmable Gamma circuit as recited in claim 12, wherein the display apparatus is a liquid crystal display.

14. A display apparatus, comprising:
a display panel;
a control/modify circuit, for outputting a plurality of Gamma setup signals, wherein each of the Gamma setup signals is in digital form and comprises a plurality of bit signals; and
a driving circuit, coupling to the control/modify circuit and the display panel, wherein the driving circuit comprises a programmable Gamma circuit, the programmable Gamma circuit receiving the Gamma setup signals, and outputting a plurality of Gamma voltage signals correspondingly according to the Gamma setup signals.

15. The display apparatus as recited in claim 14, wherein the programmable Gamma circuit comprises a plurality of Gamma units, each of the Gamma units receives one of the Gamma setup signals, and outputs one of the Gamma voltage signals correspondingly according to the Gamma setup signals that is received.

16. The display apparatus as recited in claim 15, wherein each of the Gamma units comprises:
a plurality of Gamma resistors, wherein each of the Gamma resistors has a first terminal and a second terminal, the first terminal of each of the Gamma resistors receives one of the bit signals of the Gamma setup signal correspondingly, the second terminal of each of the Gamma resistors is coupled together where current outputted from each of the Gamma resistors is summed up to a Gamma current; and
an amplifying unit, for receiving the Gamma current, and outputting one of the Gamma voltage signals correspondingly.

17. The display apparatus as recited in claim 16, wherein the amplifying unit comprises:
a feedback resistor, having a third terminal and a fourth terminal; and
an operational amplifier, having a first terminal, a second terminal and an output terminal, wherein the first terminal is coupled to a voltage level, the second terminal and the third terminal of the feedback resistor are coupled and receive the Gamma current, the output terminal and the fourth terminal of the feedback resistor are coupled and output one of the Gamma voltage signals.

18. The display apparatus as recited in claim 17, wherein the voltage level is ground voltage level.

19. The display apparatus as recited in claim 14, wherein the display panel is a liquid crystal display panel.
